(19) United States
(12) Patent Application Publication
(10) Pub. No.: US 2014/0111100 A1
(43) Pub. Date: Apr. 24, 2014

(54) CONTROL CIRCUIT FOR LIGHT-EMITTING DIODES

(71) Applicants: GUANG-DONG YUAN, Shenzhen (CN); JIN-BO WANG, Shenzhen (CN); CHUNG-CHI HUANG, New Taipei (TW)

(72) Inventors: GUANG-DONG YUAN, Shenzhen (CN); JIN-BO WANG, Shenzhen (CN); CHUNG-CHI HUANG, New Taipei (TW)

(21) Appl. No.: 13/682,761

(22) Filed: Nov. 21, 2012

(30) Foreign Application Priority Data
Oct. 18, 2012 (CN) 2012103969874

(51) Int. Cl. H05B 37/02

(52) U.S. Cl. CPC H05B 37/02
USPC 315/161

(57) ABSTRACT

A circuit includes a number of LEDs connected in series, and first and second electronic switches. An anode of a first one of the LEDs is connected to a first power supply. A control terminal of the first electronic switch receives a control signal. A first terminal of the first electronic switch is connected to a second power supply. A second terminal of the first electronic switch is grounded through a first resistor. A control terminal of the second electronic switch is connected to the second terminal of the first electronic switch. A first terminal of the second electronic switch is connected to a cathode of a last one of the LEDs. A second terminal of the second electronic switch is grounded through a second resistor.

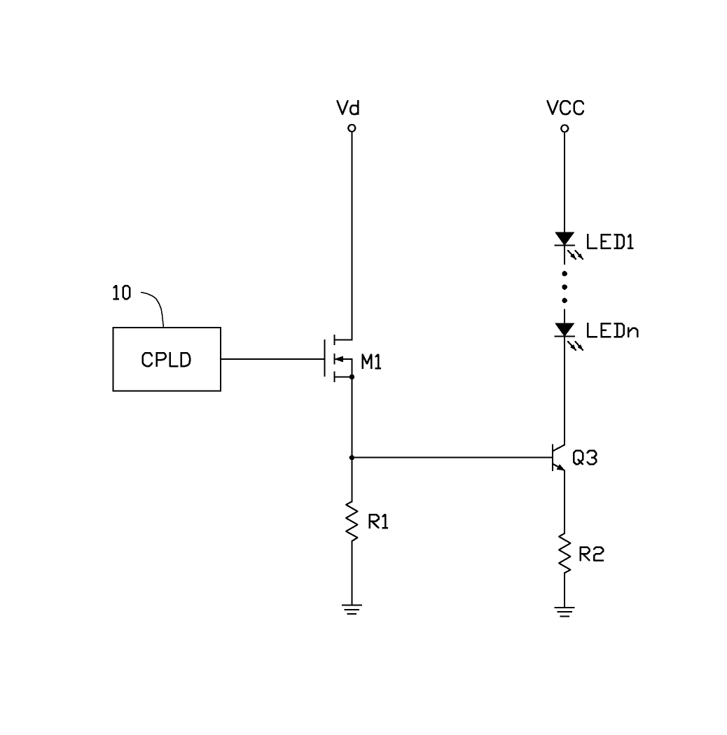

### BACKGROUND

1. Technical Field

The present disclosure relates to a circuit for controlling light-emitting diodes (LEDs).

2. Description of Related Art

In a server, operators need to check working status of the server by observing indicators set on a front panel and a back panel of the server. The indicators need to be in a same status. Nowadays, different driving circuits control the indicators. This the circuitry controlling the indicators are complicated.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments. Moreover, in the drawing, like reference numerals designate corresponding parts throughout the view.

The FIGURE is a circuit diagram of an exemplary embodiment of a control circuit.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

The FIGURE shows a control circuit of an embodiment of the disclosure. The control circuit is used to control a plurality of light-emitting diodes (LEDs) LED1-LEDn connected in series. An exemplary embodiment of the control circuit includes a metal oxide semiconductor field effect transistor (MOSFET) M1, a bipolar junction transistor (BJT) Q3, and two resistors R1 and R2. In the embodiment, the MOSFET M1 is an n-channel MOSFET, and the BJT Q3 is an npn-type BJT.

A gate of the MOSFET M1 receives a control signal from a complex programmable logic device (CPLD) 10. A source of the MOSFET M1 is grounded through the resistor R1. A drain of the MOSFET M1 is connected to a power supply Vd. The source of the MOSFET M1 is further connected to a base of the BJT Q3. An emitter of the BJT Q3 is grounded through the resistor R2. A collector of the BJT Q3 is connected to a cathode of the LED LEDn. An anode of the LED LED1 is connected to a second power supply VCC.

When the control signal is at a high level, the MOSFET M1 is turned on. A voltage received by the base of the BJT Q3 is equal to a voltage between two terminals of the resistor R1. The BJT Q3 is turned on. A resistance of the resistor R2 is selected in order to make a voltage difference between the anode and the cathode of each LED greater than a forward break-over voltage of the LED, such that the LED can be activated. The resistance of the resistor R2 satisfies the following equation:

r2=(Vcc−n*Vf)/I,

where r2 stands for the resistance of the resistor R2, Vcc stands for a voltage of the power supply VCC, n stands for a number of the LEDs LED1-LEDn, Vf stands for the forward break-over voltage of the LED, I stands for a current flowing through the LED. In the embodiment, the current I flowing through the LED is about 20 milliamperes (mA).

Furthermore, a rating power of the resistor R2 satisfies the following equation:

p>(vd−vbeq3)*I=(vd−vbeq3)*(vd−vbeq3)/r2,

where p stands for the rating power of the resistor R2, vd stands for a voltage of the power supply Vd, vbeq3 stands for a voltage difference between the base and the emitter of the BJT Q3, I stands for the current flowing through the LED, r2 stands for the resistance of the resistor R2. If the rating power of the resistor R2 is less than the rating power p, the resistor R2 may be damaged.

In the embodiment, the BJT Q3 and the MOSFET M1 function as electronic switches.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A control circuit for a plurality of light-emitting diodes (LEDs) connected in series, comprising:
a first power supply connected to an anode of a first one of the LEDs;
a first electronic switch, wherein a control terminal of the first electronic switch receives a control signal, a first terminal of the first electronic switch is connected to a second power supply, and a second terminal of the first electronic switch is grounded through a first resistor; and
a second electronic switch, wherein a control terminal of the second electronic switch is connected to the second terminal of the first electronic switch, a first terminal of the second electronic switch is connected to a cathode of a last one of the LEDs, and a second terminal of the second electronic switch is grounded through a second resistor.

2. The control circuit of claim 1, wherein the first electronic switch is a metal oxide semiconductor field effect transistor (MOSFET), a gate of the MOSFET is the control terminal of the first electronic switch, a drain of the MOSFET is the first terminal of the first electronic switch, and a source of the MOSFET is the second terminal of the first electronic switch.

3. The control circuit of claim 1, wherein the second electronic switch is a bipolar junction transistor (BJT), a base of the BJT is the control terminal of the second electronic switch, a collector of the BJT is the first terminal of the second electronic switch, and an emitter of the BJT is the second terminal of the second electronic switch.

4. The control circuit of claim 1, wherein a resistance of the second resistor satisfies the following equation:
r2=(Vcc−n*Vf)/I,
where r2 stands for the resistance of the second resistor, Vcc stands for a voltage of the first power supply, Vf stands for the forward break-over voltage of each of the LEDs, I stands for a current flowing through each LED.

5. The control circuit of claim 4, wherein a rating power of the second resistor satisfies the following equation:
p>(vd−vbeq3)*I=(vd−vbeq3)*(vd−vbeq3)/r2,
where p stands for the rating power of the second resistor, vd stands for a voltage of the second power supply, vbeq3 stands for a voltage difference between the control terminal and the second terminal of the second electronic switch, I stands for the current flowing through each LED, and r2 stands for the resistance of the second resistor.
